(19) United States
(12) Patent Application Publication
(10) Pub. No.: US 2005/0172598 A1
(43) Pub. Date: Aug. 11, 2005

(54) Agricultural mower provided with a conveyor device

(75) Inventor: Sylvain Billard, Reinhardsmunster (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: KUHN S.A., SAVERINE CEDEX (FR)

(21) Appl. No.: 11/033,132

(22) Filed: Jan. 12, 2005

(30) Foreign Application Priority Data
Jan. 19, 2004 (FR) 04 00429

(51) Int. Cl. A01D 45/02

(52) U.S. Cl. 56/192

(57) ABSTRACT

The present invention proposes a cutting machine comprising a frame, a tilting element connected to said frame by means of a first pivot articulation, a bracket connected to said tilting element by means of a second pivot articulation, a cutting mechanism connected to said bracket by means of a third pivot articulation and a conveyor device intended to move laterally the product cut by said cutting mechanism. The said conveyor device is connected to said tilting element in such a manner as to be able to pivot relative to said frame about said first articulation together with said cutting mechanism.

### BACKGROUND OF THE INVENTION

1. Field of the Invention

The present invention relates to the general technical field of agricultural machinery. It concerns more precisely a cutting machine comprising:
a frame,
a tilting element connected to said frame by means of a first pivot articulation with an upwardly directed axis,
a bracket connected to said tilting element by means of a second pivot articulation with an axis directed in the direction of travel during work,
a cutting mechanism intended to cut a standing product, said cutting mechanism being connected to said bracket by means of a third pivot articulation with an axis directed in said direction of travel during work, and
a conveyor device intended to move sideways the product cut by said cutting mechanism.

2. Discussion of the Background

Such a cutting machine is disclosed by document DE 202 04 398 U1. On this known machine, the conveyor device is connected to a secondary frame by means of a second tilting element. For its part, the secondary frame is removably connected to the frame supporting the cutting mechanism. Consequently, the user may remove the secondary frame in order to use the cutting machine without the conveyor device. This known cutting machine therefore has the advantage of being multipurpose. However, this solution has the disadvantage of requiring a second tilting element and a secondary frame, hence an increase in the manufacturing cost and the total mass of the machine. In addition, the transition between a configuration in which the cutting machine comprises the conveyor device to a configuration in which the cutting machine does not comprise the conveyor device does not seem to be practical to carry out. Specifically, the user must first of all separate the secondary frame from the frame supporting the cutting mechanism. This operation is without doubt lengthy and awkward to carry out. Then the secondary frame and the conveyor device must be stored until they are next used. If, during work, the ground conditions are such that it is again advantageous to group the cut product, the user must then return to the location in which the secondary frame and the conveyor device have been stored in order to carry out the reassembly. Hence, again, a considerable waste of time. These constraints are such that the user will certainly not often adapt his cutting machine to the ground conditions.

On this known machine, the second tilting element is connected to the secondary frame by means of a pivot articulation. The axis of this pivot articulation is parallel to the axis of the first pivot articulation while being offset rearward relative to the latter. If an obstacle is encountered during work, said cutting mechanism and the conveyor device then pivot rearward about their respective pivot articulation. During this rearward pivoting, a relative movement occurs between the cutting mechanism and the conveyor device, transverse to the direction of travel during work. Owing to this offset, it may be that a portion of the cut product coming out of the cutting mechanism falls beside the conveyor device, hence a loss of crop unacceptable to the user.

### SUMMARY OF THE INVENTION

The purpose of the present invention is to improve the cutting machine of the prior art by simplifying its construction, in particular in order to reduce its manufacturing cost, and by avoiding any loss of cut product during any possible rearward pivoting of said cutting mechanism about the first articulation.

Therefore, the cutting machine according to the present invention is characterized in that said conveyor device is connected to said tilting element in such a manner as to be able to pivot relative to said frame about said first pivot articulation together with said cutting mechanism.

This considerably reduces the number of parts necessary to the attachment of said conveyor device hence the simplification and reduction in manufacturing cost. In addition, the cutting mechanism and the conveyor device now pivot together about one and the same axis. There is therefore no longer any transverse relative movement during the rearward pivoting of the cutting mechanism and the conveyor device. Any loss of cut product is thereby avoided.

### BRIEF DESCRIPTION OF THE DRAWINGS

Other features of the invention, to be considered separately or in all their possible combinations, will become further apparent in the following description of an exemplary, non-limiting embodiment of the invention represented in the appended drawings, in which:

FIG. 1 represents, seen from above, a cutting machine according to the present invention,

FIG. 2 represents, seen from above, the cutting machine of FIG. 1 after rearward pivoting of the cutting mechanism and of the conveyor device,

FIG. 3 represents, seen from the side, the cutting machine of FIG. 1 with the conveyor device in working position,

FIG. 4 represents, seen from the side, the cutting machine of FIG. 1 with the conveyor device in a raised position.

### DESCRIPTION OF THE PREFERRED EMBODIMENTS

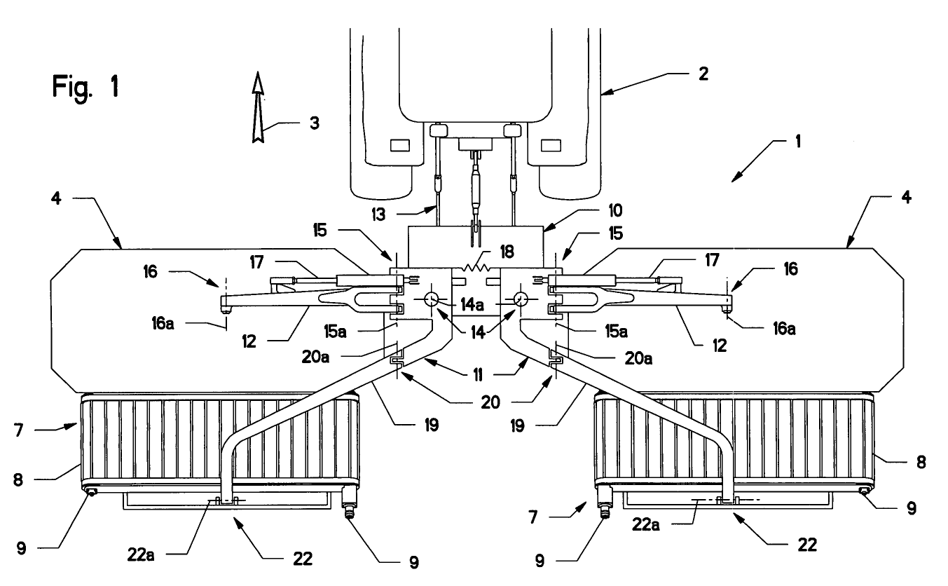

FIG. 1 represents, seen from above, a cutting machine 1 complying with the present invention. Said cutting machine 1 is hitched to a motor vehicle 2 which pulls it during work in a line and direction of travel represented by the arrow 3. In the rest of the description, the following concepts, “front” and “rear”, “in front of” and “behind” are defined relative to the direction of travel 3 and the concepts “right” and “left” are defined when looking at said cutting machine 1 from the rear in the direction of travel 3.

In a manner known to those skilled in the art, said cutting machine 1 comprises a cutting mechanism 4 intended to cut a standing product, such as grass for example. During work, said cutting mechanism 4 is placed to the rear and to the right side of said motor vehicle 2. In the exemplary embodiment represented in the figures, said cutting machine 1 advantageously comprises a second cutting mechanism 4 placed, during work, to the rear and to the left side of said motor vehicle 2. The presence of the two cutting mechanisms 4 allows an increase in the working width of said cutting machine 1. The rest of the description will apply without distinction to one or other side of said cutting machine 1.

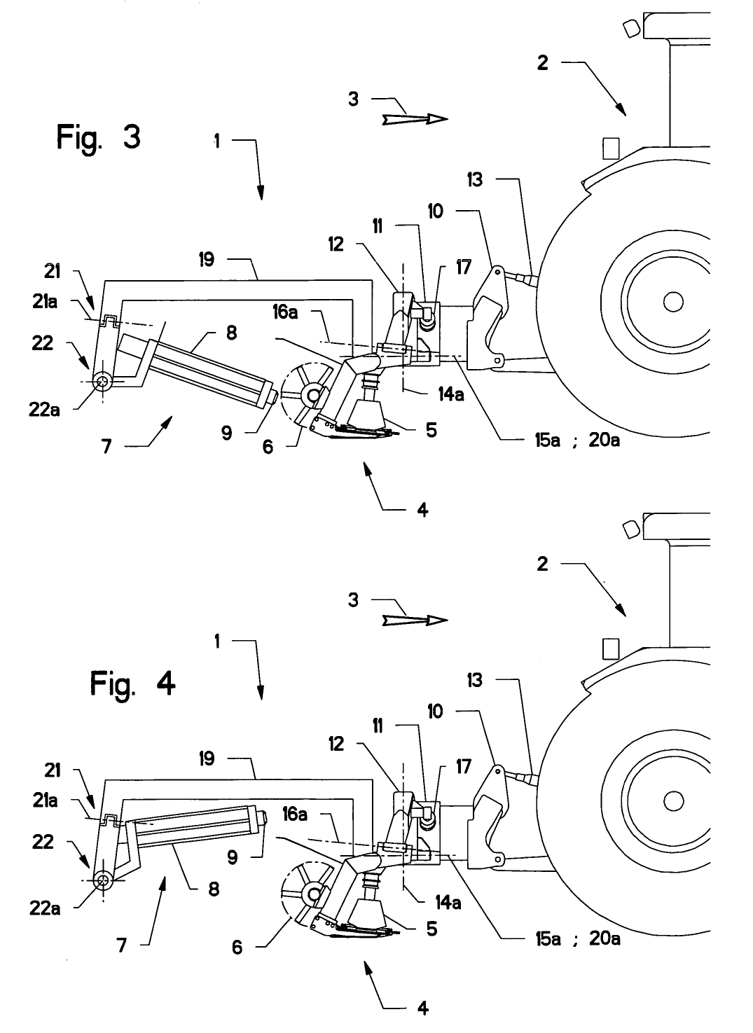

As shown in FIGS. 3 and 4, said cutting mechanism 4 comprises cutting elements 5 placed one beside the other. During work, said cutting mechanism 4 extends transverse to said direction of travel 3 and said cutting elements 5 are driven in rotation about an upwardly directed respective axis. Preferably, said cutting mechanism 4 further comprises a conditioning device 6 intended to accelerate the drying of the cut product. Said conditioning device 6 is made for example by means of a rotor fitted with flails as shown in FIGS. 3 and 4. Such a cutting mechanism 4 is commonly employed on mowers and mower-conditioners known to those skilled in the art; it will therefore not be described further.

Said cutting machine 1 further comprises a conveyor device 7 intended to move, transverse to said direction of travel 3, the cut product coming out of said cutting mechanism 4. Said conveyor device 7 thus advantageously makes it possible for the cut product to be deposited on a swath already present on the ground or, depending on the case, to group into a single swath the cut product coming out of several cutting mechanisms 4. To do this, said conveyor device 7 comprises for example an endless belt 8 wound around two rollers 9, at least one of which is a drive roller. Said conveyor device 7 is placed behind said cutting mechanism 4 such that the cut product, where necessary after conditioning, falls on the top driving side of said endless belt 8.

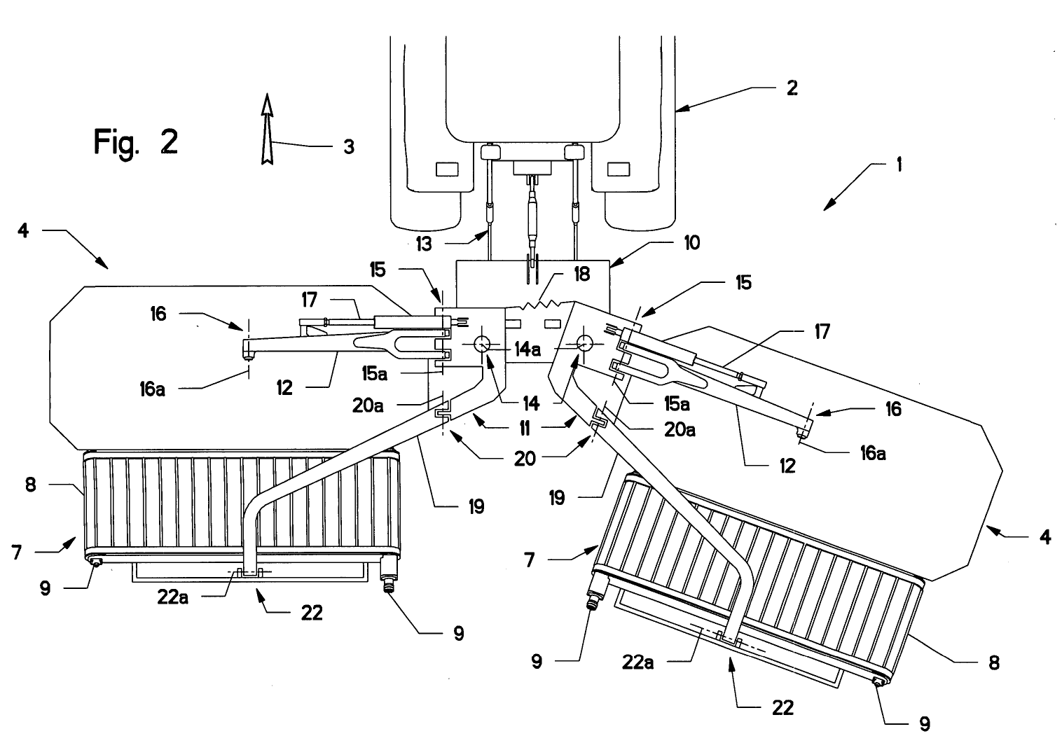

Said cutting machine 1 also comprises a frame 10, a tilting element 11 and a bracket 12. Said frame 10 is intended to be connected to a hitching device 13 of said motor vehicle 2. Said tilting element 11 is connected to said frame 10 by means of a first pivot articulation 14 with an upwardly directed axis 14a. One end of said bracket 12 is connected to said tilting element 11 by means of a second pivot articulation 15 with an axis 15a directed in said direction of travel 3. The other end of said bracket 12 is connected to said cutting mechanism 4 by means of a third pivot articulation 16 with an axis 16a also directed in said direction of travel 3. As seen in FIGS. 1 and 2, for the cutting machines 1 comprising two cutting mechanisms 4, said tilting elements 11 are connected to a single frame 10.

Said first articulation 14 advantageously allows said cutting mechanism 4 to pivot rearward relative to said frame 10 if an obstacle is encountered. Said cutting machine 1 is preferably fitted with a holding device 18 used to keep said cutting mechanism 4 within a certain limit in its working position but allowing rearward pivoting in the event of too great a force. Advantageously, said holding device 18 is also used to automatically return said cutting mechanism 4 to its working position after the obstacle is passed. Such a holding device 18 is known to those skilled in the art, so it will not be described further. Said second articulation 15 and said third articulation 16 allow said cutting mechanism 4 to follow the undulations of the ground during work irrespective of the position of said frame 10. Preferably, said cutting machine 1 further comprises a lightening and maneuvering device 17 intended during work to transfer at least a portion of the weight of said cutting mechanism 4 onto said frame 10. Said lightening and maneuvering device 17 is also used to pivot said cutting mechanism 4 upward about said second articulation 15 in order to reach a transport position. Such a lightening and maneuvering device 17 is produced for example by means of a hydropneumatic cylinder.

According to an important feature of the present invention, said conveyor device 7 is connected to the same tilting element 11 in such a manner as to be able to pivot relative to said frame 10 about said first articulation 14 together with said cutting mechanism 4.

Accordingly, in the exemplary embodiment shown in the figures, said conveyor device 7 is connected to said tilting element 11 by means of a support arm 19. Preferably, one end of said support arm 19 is connected to said tilting element 11 by means of a fourth pivot articulation 20 whose axis 20a is preferably at least substantially coincident with the axis 15a of said second articulation 15. Said conveyor device 7 may thus be pivoted upward about said fourth articulation 20 in order to reach a transport position. In an equally preferable manner, and as seen more precisely in FIGS. 3 and 4, the other end of said support arm 19 is connected to said conveyor device 7 by means of a fifth articulation 21 whose axis 21a is advantageously at least substantially coincident with the axis 16a of said third articulation 16. During work, said conveyor device 7 may thus perfectly follow the movements of said cutting mechanism 4 in order to avoid any loss of forage. Accordingly, support points are advantageously provided between said conveyor device 7 and said cutting mechanism 4. Said cutting machine 1 also comprises a second lightening and maneuvering device, not shown, intended, during work, to transfer at least a portion of the weight of said conveyor device 7 onto said frame 10. Said second lightening and maneuvering device is also intended to pivot said conveyor device 7 upward about said fourth articulation 20 to reach the transport position. Said lightening and maneuvering device 17 and said second lightening and maneuvering device may advantageously be controlled and/or adjusted simultaneously from the control position of said motor vehicle 2.

In a particularly advantageous manner, a sixth pivot articulation 22 is also provided between said conveyor device 7 and the closest end of said support arm 19. During work, the axis 22a of said sixth articulation 22 is at least substantially horizontal and transverse to said direction of travel 3. A driving element is provided to pivot said conveyor device 7 about said sixth articulation 22. Thus, as seen in FIGS. 3 and 4, said endless belt 8 may occupy at least two positions relative to said support arm 19. In FIG. 3, said endless belt 8 occupies an active position. In this active position, the flow of cut product coming out of said cutting mechanism 4 falls on the top side of said endless belt 8 in order to be moved laterally. However, in FIG. 4, said endless belt 8 occupies an inactive position. Here, the flow of cut product coming out of said cutting mechanism 4 passes beneath said endless belt 8 and thus falls directly on the ground without having been moved laterally. Another driving element controlled from the control position of said motor vehicle 2 allows said conveyor device 7 to be tilted about said sixth articulation 22. The user can thus very easily and very quickly change the configuration of said cutting machine 1 according to the ground conditions.

The cutting machine 1 that has just been described is only an example that in no circumstances limits the field of protection defined in the following claims.

Thus, said cutting machine 1 may yet comprise a third cutting mechanism placed in front of said motor vehicle 2. According to another exemplary embodiment, said conveyor device 7 is produced by means of rollers placed side by side and driven in rotation.

1. A cutting machine comprising:
a frame,
a tilting element connected to said frame by means of a first pivot articulation with an upwardly directed axis,
a bracket connected to said tilting element by means of a second pivot articulation with an axis directed in the direction of travel during work,
a cutting mechanism intended to cut a standing product, said cutting mechanism being connected to said bracket by means of a third pivot articulation with an axis directed in said direction of travel during work, and
a conveyor device intended to move sideways the product cut by said cutting mechanism,
wherein said conveyor device is connected to said tilting element in such a manner as to be able to pivot relative to said frame about said first articulation together with said cutting mechanism.

2. Cutting machine as claimed in claim 1, wherein said conveyor device is connected to said tilting element by means of a support arm and one end of said support arm is connected to said tilting element by means of a fourth pivot articulation.

3. Cutting machine as claimed in claim 2, wherein an axis of said fourth pivot articulation is at least substantially coincident with an axis of said second articulation.

4. Cutting machine as claimed in claim 2, wherein said support arm is connected to said conveyor device by means of a fifth pivot articulation.

5. Cutting machine as claimed in claim 4, wherein an axis of said fifth pivot articulation is at least substantially coincident with an axis of said third articulation.

6. Cutting machine as claimed in claim 1, which said cutting machine comprises a lightening and maneuvering device intended, during work, to transfer at least a portion of the weight of said cutting mechanism onto said frame, and intended to pivot said cutting mechanism upward about said second articulation to reach a transport position.

7. Cutting machine as claimed in claim 6, which said cutting machine comprises a second lightening and maneuvering device intended, during work, to transfer at least a portion of the weight of said conveyor device onto said frame, and intended to pivot said conveyor device upward about said fourth articulation to reach a transport position.

8. Cutting machine as claimed in claim 7, wherein said lightening and maneuvering device and said second lightening and maneuvering device may advantageously be controlled and/or adjusted simultaneously.

9. Cutting machine as claimed in claim 2, which said cutting machine comprises a sixth pivot articulation between said conveyor device and the closest end of said support arm.

10. Cutting machine as claimed in claim 9, wherein an axis of said sixth articulation is at least substantially horizontal and transverse to said direction of travel.
